(19) United States
(12) Patent Application Publication
(10) Pub. No.: US 2025/0086276 A1
(43) Pub. Date: Mar. 13, 2025

(54) MAIL SECURITY PROCESSING DEVICE OF MAIL ACCESS SECURITY SYSTEM THAT PROVIDES ACCESS MANAGEMENT AND BLOCKING FUNCTION BASED ON EMAIL COMMUNICATION PROTOCOL, AND OPERATION METHOD THEREOF

(71) Applicant: KIWONTECH CO., LTD., Seoul (KR)

(72) Inventor: Chung Han KIM, Seoul (KR)

(21) Appl. No.: 18/571,708

(22) PCT Filed: Jul. 19, 2023
(86) PCT No.: PCT/KR2023/010365

§ 371 Date: Dec. 18, 2023

(30) Foreign Application Priority Data
Jul. 22, 2022 (KR) 10-2022-0091025

(51) Int. Cl. G06F 21/55

(52) U.S. Cl. CPC G06F 21/554; G06F 2221/034

(57) ABSTRACT

According to an embodiment of the present invention, there is provided an operation method of a mail security device that configures a security network of a mail access security system and includes a security threat inspection unit for performing a security threat inspection corresponding to an inbound mail, and a mail processing unit for transferring the mail for which the security threat inspection has been completed to a mail server in the security network.

### TECHNICAL FIELD

The present invention relates to a mail security processing device and an operation method thereof. More specifically, the present invention relates to a mail security processing device of a mail access security system that provides an access management and blocking function based on an email communication protocol, and an operation method thereof.

### BACKGROUND ART

With the advancement in computers and information and communication technologies, today's society is getting more dependent on cyberspaces in all areas of social life across the world, and this trend is further accelerated. In recent years, as 5G mobile communications with ultra-high speed, ultra-low latency, and ultra-connectivity are commercialized and new services based thereon have emerged, cybersecurity systems have become more important.

As cybersecurity systems are constructed, technical fields such as the Internet of Things (IoT), cloud systems, big data, artificial intelligence (AI), and the like are combined with information and communication technologies to provide a new service environment. Systems that provide these services can be used in real life in connection with PCs, portable terminal device, or the like through the Internet or wireless networks.

Particularly, email systems used in information and communication technology may provide email services including a message body to exchange messages using communication lines between users through computer terminals. At this point, electronic files containing contents to be shared may be attached to an email, or resource connection links (URL; Uniform Resource Locator) may be written in the message body or inserted in an attached file.

However, concerns about security of email and data exchange are increasing recently. Particularly, as mail servers that process transmission and reception of emails are exposed to various threats due to hacking, phishing mail, account takeover, personal information leakage, and the like, the need of security for the mail servers is increasing day by day.

Accordingly, various security system solutions, which detect basic threats to data packets that the mail servers receive from the outside, and notify and filter the threats when the threats are detected, are developed and applied currently by constructing separate security systems such as a firewall or the like to protect the mail servers, and configuring security networks to protect the mail servers for reception of mails.

However, as mail hacking methods are also advanced gradually, attacks of stealing mails or accounts and distributing malicious mails are attempted recently by bypassing the security networks and using a mail server access process based on a communication protocol for mail engine, and this is difficult to detect only by inspecting threats to data packets.

This is utilizing an access process based on a communication protocol for mail engine to directly access a mail server itself for attacking purpose by abusing the vulnerabilities of a system, i.e., the detailed email contents in the packets of communication protocol for mail engine are difficult to confirm with only firewalls or general security inspection systems.

More specifically, the communication protocol for mail engine is a specification for transmitting and receiving email by directly communicating with a mail server when an access address dedicated to the email protocol of the mail server is confirmed, which is a communication protocol for email set in advance, and contents of data may be confirmed only when there is a mail engine module that can decrypt and encrypt email. According to email standards, Simple Mail Transfer Protocol (SMTP) standard protocol, Post Office Protocol 3 (POP3) standard protocol, Internet Message Access Protocol (IMAP) standard protocol, Message Application Programming Interface (MAPI) standard protocol, or the like is used.

Packets based on the communication protocol for mail engine are transmitted and received after being encrypted on the basis of the Transport Layer Security Protocol (TLS), and each mail server may have access address information dedicated to the mail protocol for transmitting and receiving email data by communicating on the basis of the Transport Layer Security Protocol (TLS).

In addition, the Outlook program or various mail client applications that are mainly installed in an external mail access device are configured to set access address (path) information and port information dedicated to each mail protocol such as SMTP, POP3, IMAP, or MAPI, and when access address (path) information and port information dedicated to a mail protocol are set, external mail access devices may directly exchange email packets with the mail server on the basis of the communication protocol for mail engine, which are difficult to decode on a normal security system.

However, since a mail engine module that can confirm contents of the email packets is not provided in the current security systems that only perform firewall functions or detect malware in the packets, detailed contents of the packets based on the communication protocol for mail engine cannot be confirmed, and therefore, there is a problem in that although an attacker repeatedly attempts account takeover access attacks to the access address dedicated to the communication protocol for mail engine with a malicious intent or transmits innumerable spam mails and malicious mails to a stolen account while indefinitely changing the email ID or password, this cannot be grasped.

Furthermore, when an attack based on accessing the communication protocol for mail engine is attempted, the current system cannot even grasp whether the type of the attack is account takeover, malicious email distribution, or personal information leakage.

### DISCLOSURE OF INVENTION

### Technical Problem

Therefore, the present invention has been made in view of the above problems, and it is an object of the present invention to provide a mail security processing device of a mail access security system that provides an access management and blocking function based on an email communication protocol, and an operation method thereof, which constructs a security system based on a mail security device, which constructs a security network to protect a mail server from email attacks by performing a security threat inspection corresponding to a mail transmitted to and received from an existing mail server system in the middle while maintaining the mail server system, and is configured to detect and block malicious attempts of mail server access based on a communication protocol for mail engine, by the mail security device in advance, by directing the access path information based on the communication protocol for mail engine to the mail security device, and is accordingly capable of efficiently protecting the mail server from attacks based on the mail engine protocol to the mail server.

### Technical Solution

To accomplish the above object, according to one aspect of the present invention, there is provided an operation method of a mail security device that configures a security network of a mail access security system and includes a security threat inspection unit for performing a security threat inspection corresponding to an inbound mail, and a mail processing unit for transferring the mail for which the security threat inspection has been completed to a mail server in the security network, the method comprising the steps of: receiving mail server access request information from an external mail access device on the basis of access path information based on a mail communication protocol previously distributed to the outside of the security network of the mail access security system, by the mail security device; acquiring one or more pieces of detailed access information included in the mail server access request information by inputting the mail server access request information into a communication protocol processing module for mail engine used by the security threat inspection unit and the mail processing unit, by the mail security device; determining whether or not to block the access using the one or more pieces of detailed access information, by the mail security device; and blocking transfer of the mail server access request information to the mail server according to the determination of whether or not to block the access, by the mail security device.

According to another aspect of the present invention, there is provided a mail security device that configures a security network of a mail access security system and includes a security threat inspection unit for performing a security threat inspection corresponding to an inbound mail, and a mail processing unit for transferring the mail for which the security threat inspection has been completed to a mail server in the security network, the device comprising: a communication unit for receiving mail server access request information from an external mail access device on the basis of access path information based on a mail communication protocol previously distributed to the outside of the security network of the mail access security system; a mail server access request information processing unit for acquiring one or more pieces of detailed access information included in the mail server access request information by inputting the mail server access request information into a communication protocol processing module for mail engine used by the security threat inspection unit and the mail processing unit; a blocking determination unit for determining whether or not to block the access using the one or more pieces of detailed access information; and an access blocking processing unit for blocking transfer of the mail server access request information to the mail server according to the determination of whether or not to block the access.

### Advantageous Effects

According to an embodiment of the present invention, a mail security device configuring a mail access security system may receive mail server access request information from an external mail access device on the basis of access path information based on a mail communication protocol previously distributed to the outside of the security network of the mail access security system, acquire one or more pieces of detailed access information included in the mail server access request information by inputting the mail server access request information into a communication protocol processing module for mail engine used by the security threat inspection unit and the mail processing unit, and determine whether or not to block the access using the one or more pieces of detailed access information.

Accordingly, the security system according to an embodiment of the present invention constructs a security system based on a mail security device, which constructs a security network to protect a mail server from email attacks by performing a security threat inspection corresponding to a mail transmitted to and received from an existing mail server system in the middle while maintaining the mail server system, and is configured to detect and block malicious attempts of mail server access based on a communication protocol for mail engine, by the mail security device in advance, by directing the access path information based on the communication protocol for mail engine to the mail security device, and is accordingly capable of efficiently protecting the mail server from attacks based on the mail engine protocol to the mail server.

As a security system according to an embodiment of the present invention is configured, malicious attempts of direct access to a mail server based on a communication protocol for mail engine are blocked, and this may reduce the load on the mail server, and also detect each attack type by decoding information on the malicious attempts of direct access to a mail server based on a communication protocol for mail engine, and appropriately respond to the attack, there is an advantage of constructing an email security system more efficiently.

### BRIEF DESCRIPTION OF THE DRAWINGS

FIG. 1 is a conceptual view schematically showing the entire system according to an embodiment of the present invention.

FIG. 2 is a block diagram showing in more detail a mail security device according to an embodiment of the present invention.

FIG. 3 is a block diagram showing in more detail a security threat inspection unit and a mail processing unit according to an embodiment of the present invention.

FIG. 4 is a block diagram showing in more detail a mail server access security authentication processing unit of a mail security device according to an embodiment of the present invention.

FIG. 5 is a flowchart for explaining the operation of a mail security device according to an embodiment of the present invention.

### BEST MODE FOR CARRYING OUT THE INVENTION

Hereinafter, only the principles of the present invention will be exemplified. Therefore, although not clearly described or shown in this specification, those skilled in the art will be able to implement the principles of the present invention and invent various devices included in the spirit and scope of the present invention. In addition, it should be understood that all conditional terms and embodiments listed in this specification are, in principle, clearly intended only for the purpose of understanding the concept of present invention, and not limited to the embodiments and states specially listed as such.

In addition, it should be understood that all detailed descriptions listing specific embodiments, as well as the principles, aspects, and embodiments of the present invention, are intended to include structural and functional equivalents of such matters. In addition, it should be understood that such equivalents include equivalents that will be developed in the future, as well as currently known equivalents, i.e., all devices invented to perform the same function regardless of the structure.

Accordingly, for example, the block diagrams in the specification should be understood as expressing the conceptual viewpoints of illustrative circuits that embody the principles of the present invention. Similarly, all flowcharts, state transition diagrams, pseudo code, and the like may be practically embodied on computer-readable media, and it should be understood that regardless of whether or not a computer or processor is explicitly shown, they show various processes performed by the computer or processor.

In addition, explicit use of the terms presented as processors, controls, or concepts similar thereto should not be interpreted by exclusively quoting hardware having an ability of executing software, and should be understood to implicitly include, without limitation, digital signal processor (DSP) hardware, and ROM, RAM and non-volatile memory for storing software. Other known common hardware may also be included.

The above objects, features and advantages will become more apparent through the following detailed description related to the accompanying drawings, and accordingly, those skilled in the art may easily implement the technical spirit of the present invention. In addition, when it is determined in describing the present invention that the detailed description of a known technique related to the present invention may unnecessarily obscure the gist of the present invention, the detailed description thereof will be omitted.

The terms used in this specification are used only to describe specific embodiments, and are not intended to limit the present invention. Singular expressions include plural expressions unless the context clearly dictates otherwise. It should be understood that in this specification, terms such as “comprise” or “have” are intended to specify existence of a feature, a number, a step, an operation, a component, a part, or a combination thereof described in the specification, not to preclude the possibility of existence or addition of one or more other features, numbers, steps, operations, components, parts, or combinations thereof.

Hereinafter, preferred embodiments of the present invention will be described in more detail with reference to the accompanying drawings. In describing the present invention, in order to facilitate the overall understanding, the same reference numerals are used for the same components in the drawings, and duplicate descriptions of the same components are omitted.

A ‘mail (email)’ used in this specification may collectively refer to terms such as electronic mail, web email, electronic mail, electronic mail materials, and the like exchanged between a user and a terminal device using a computer communication network through a client program installed in the terminal device or a website.

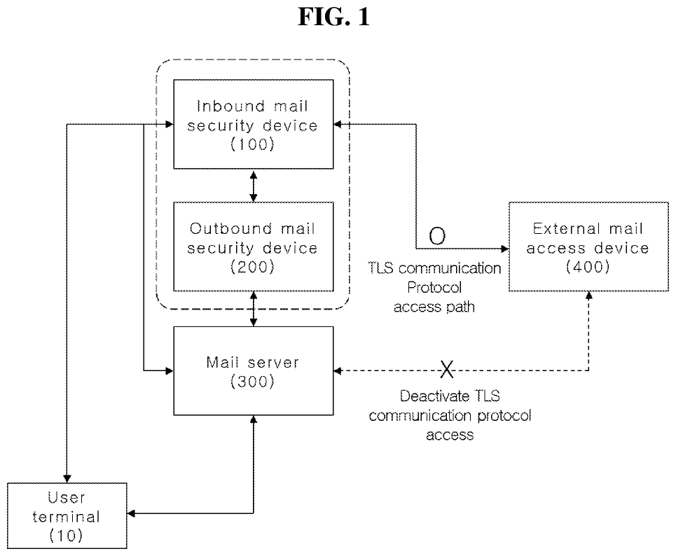

FIG. 1 is a conceptual view schematically showing the entire system according to an embodiment of the present invention.

Referring to FIG. 1, the system according to an embodiment of the present invention includes a user terminal 10, an inbound mail security device 100, an outbound mail security device 200, a mail server 300, and an external mail access device 400.

More specifically, the inbound mail security device 100, the outbound mail security device 200, and the mail server 300 may form a separately secured security network. The security network is a security network that can transmit a mail to the mail server 300 only through the inbound mail security device 100 and the outbound mail security device 200, and each device may be equipped with a secure internal network and security devices based on various network interface environments for this purpose.

Here, the devices configuring the network may be connected to each other through a wired/wireless network, and the devices or terminals connected to each network may communicate with each other through a secure network channel.

Here, each of the networks may be implemented as various types of wired/wireless networks, such as a local area network (LAN), a wide area network (WAN), a value-added network (VAN), a personal area network (PAN), a mobile communication network, or a satellite communication network.

In addition, although the user terminal 10 and the external mail access device 400 described in this specification may include a personal computer (PC), a laptop computer, a mobile phone, a tablet PC, a Personal Digital Assistant (PDA), a Portable Multimedia Player (PMP), and the like, the present invention is not limited thereto, and various devices connectable to the mail server 300 or the inbound mail security device 100 through an internal network, a public network, or a private network may be exemplified. In addition, the user terminal 10 and the external mail access device 400 may be a variety of devices capable of inputting and outputting information through application driving or web browsing.

In addition, the inbound mail security device 100 and the outbound mail security device 200 may perform a security threat inspection on email data received and transmitted from the external mail access device 400 to the account of the user terminal 10 through the mail server 300, and configure a mail security system that blocks or allows a process of receiving and transmitting mails that have completed the security threat inspection.

Although the inbound mail security device 100 and the outbound mail security device 200 are shown to be separately configured in FIG. 1, according to embodiments of the present invention, the inbound mail security device 100 and the outbound mail security device 200 may be configured as a single mail security device.

Unlike the security network system and operation, the external mail access device 400 located in the external network is connected in one or more of wired and wireless methods through connection to a public network to transmit and receive data. The public network is a communication network constructed and managed by the country or a telecommunication infrastructure operator, and generally includes a telephone network, a data network, a CATV network, a mobile communication network, and the like to provide connection services so that unspecified many people may access other communication networks or the Internet.

According to the background art described above, the external mail access device 400 may confirm access information of the mail server 300 based on a communication protocol for mail engine for the purpose a malicious attempt of direct access to a mail server based on the communication protocol for mail engine, and attempt an access based on the communication protocol for mail engine according to the access information. This communication protocol for mail engine may be generally configured of packets encrypted based on the Transport Layer Security (TLS) protocol, and the access information based on the communication protocol for mail engine of the mail server 300 is generally distributed to the external mail access device 400.

Here, as described above, the communication protocol for mail engine may include at least one among the Simple Mail Transfer Protocol (SMTP) standard protocol, the Post Office Protocol 3 (POP3) standard protocol, the Internet Message Access Protocol (IMAP) standard protocol, and the Message Application Programming Interface (MAPI) standard protocol.

However, according to an embodiment of the present invention, access information of the inbound mail security device 100 based on the communication protocol for mail engine may be distributed in replace of the access information of the mail server 300 based on the communication protocol for mail engine. That is, distribution itself of the TLS communication protocol access path information to the mail server 300 may be blocked in advance, and this path may be deactivated in advance. For example, the mail server 300 may also deactivate the existing TLS communication protocol access path in advance by setting to block the port so as not to allow access itself to the access path.

Through the access path deactivation, the external mail access device 400 may access the mail server 300 only through the inbound mail security device 100, and a TLS communication protocol access path for this purpose may be formed. To form the TLS communication protocol access path, the inbound mail security device 100 may distribute the access information of the inbound mail security device 100 based on the communication protocol for mail engine in replace of the access information of the mail server 300 based on the communication protocol for mail engine as described above.

Accordingly, the inbound mail security device 100 may receive mail server access request information from the external mail access device 400 on the basis of access path information based on the mail communication protocol previously distributed to the outside of the security network of the mail access security system.

In addition, the inbound mail security device 100 may acquire one or more pieces of detailed access information included in the mail server access request information by inputting the mail server access request information into the communication protocol processing module for mail engine used by the security threat inspection unit and the mail processing unit provided for the security of reception and transmission of email as described above.

In addition, the inbound mail security device 100 may determine whether or not to block the access using the one or more pieces of detailed access information, and may block or allow transfer of the mail server access request information to the mail server 300 according to the determination of whether or not to block the access.

Here, as the one or more pieces of detailed access information may include at least one among mail user identification information, encrypted mail user password information, device identification information, access IP information, access location information, access time information, and identification information of communication protocol for mail engine, when blocking policy information previously configured in correspondence to the mail user identification information matches at least one among the device identification information, the access IP information, the access location information, the access time information, and the identification information of communication protocol for mail engine, the inbound mail security device 100 may determine to block the access.

Furthermore, the blocking policy information may include learning-based blocking policy information variably configured according to learning data of activity information previously collected in correspondence to the mail user identification information, and the activity information may include at least one among the device identification information, the access IP information, the access location information, the access time information, and the identification information of communication protocol for mail engine corresponding to the mail user identification information.

In addition, when the identification information of communication protocol for mail engine set in advance in correspondence to the mail user identification information is different from the identification information of communication protocol for mail engine, the inbound mail security device 100 may inquire the user terminal 10, which is set in advance in correspondence to the mail user identification information, whether or not to block the mail server access request information. In this case, the inbound mail security device 100 may determine to block or allow the access according to the response data received from the user terminal 10 in response to the inquiry.

In addition, based on the information on the mail server access request that is not blocked and is eventually allowed according to the determination of whether or not to block the access, the inbound mail security device 100 may transmit authentication inquiry information including the mail user identification information and the encrypted mail user password information to the mail server 300, and transmit the mail server access request information to the mail server 300 according to the authentication response of the mail server 300 corresponding to the authentication inquiry information.

In this case, the inbound mail security device 100 may acquire mail server access response information corresponding to the mail server access request information from the mail server 300, and transmit the mail server access response information to the external mail access device 400.

According to the system configuration, although the external mail access device 400 actually performs TLS-based communication using a communication protocol for mail engine such as SMTP, POP3, IMAP, MAPI, or the like, transmission and reception of email data to and from the mail server 300 is allowed only through the inbound mail security device 100, and as at least part of email packets based on the communication protocol for mail engine is decoded using an email engine module for security threat inspection, the inbound mail security device 100 may compare the email with a preset policy, and block the email or grasp whether the email is an attack and an attack type and process a notification to the user terminal 10.

Accordingly, as the email security system according to an embodiment of the present invention may identify and block the direct access attack on the mail server 300 based on the protocol for mail engine without additionally constructing a separate system while maintaining the existing mail server-based transmission and reception security system, and allow email exchange with the mail server 300 in the case of a normal access request based on a protocol for mail engine, an efficient and safe email transmission and reception security system can be constructed.

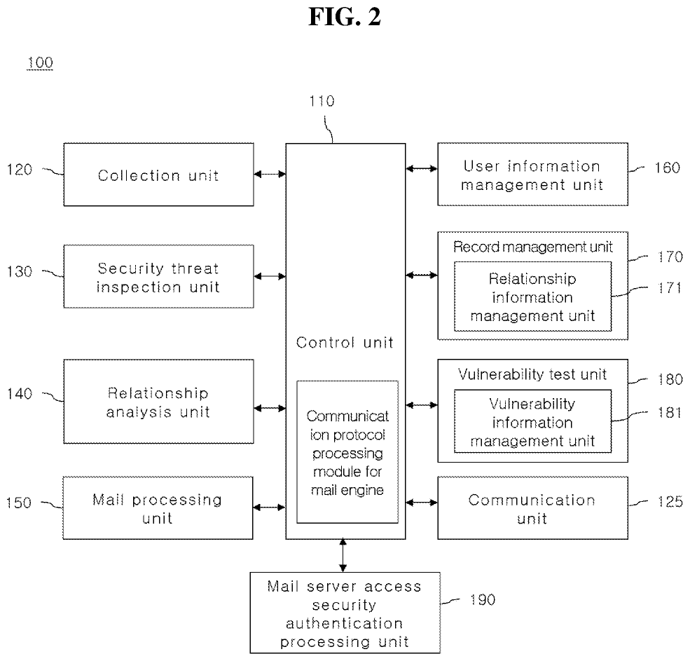

FIGS. 2 to 4 are block diagrams for explaining in more detail the inbound mail security device 100 according to an embodiment of the present invention.

Referring to FIGS. 2 to 4, first, the inbound mail security device 100 according to an embodiment of the present invention includes a control unit 110, a collection unit 120, a security threat inspection unit 130, a relationship analysis unit 140, a mail processing unit 150, a user information management unit 160, a record management unit 170, a vulnerability test unit 180, a communication unit 125, and a mail server access security authentication processing unit 190.

The control unit 110 may be implemented as one or more processors to control the overall operation of each component of the inbound mail security device 100.

In addition, the control unit 110 is provided with a communication protocol processing module for mail engine, and as it decrypts, encrypts, or modulates data based on the email communication protocol processed in each component, data processing on the packets of communication protocol for mail engine is allowed.

The communication unit 125 may include one or more communication modules for communicating with a network where the user terminal 10 or the mail server 300 is located, or with the external mail access device 400.

In addition, the collection unit 120 may restore the packets of communication protocol for mail engine transmitted and received to and from the mail server 300 or the external mail access device 400, and collect mail information of the received and transmitted email packet data. The mail information may include email header information, email subject, email message body, the number of times of receiving emails during a predetermined period, and the like.

Specifically, the email header information may include the IP address of the mail sending server, information on the host name of the mail sending server, information on the mail domain of the sender, the mail address of the sender, the IP address of the mail receiving server, information on the host name of the mail receiving server, information on the mail domain of the receiver, the mail address of the receiver, information on the mail protocol, information on the time of receiving the mail, information on the time of sending the mail, and the like.

In addition, the email header may include network path information required in the process of sending and receiving mail, information on the protocol used between mail service systems for exchanging mail, and the like.

In addition, the mail information may include an extension of an attached file, hash information of the attached file, a name of the attached file, a contents body of the attached file, uniform resource locator (URL) information, and the like. The attached file may include additional contents for transferring additional information or requesting reply of information, in addition to the message body of the mail that the sender desires to transfer to the receiver.

The contents may provide text, images, videos, and the like. The receiver may confirm the contents by executing an application corresponding to the file attached to the mail. In addition, the receiver may download the file attached to the mail to a local storage device to store and manage therein.

The extension of an attached file may distinguish a file format or type. The extension of an attached file may be generally distinguished by a character string indicating file attributes or an application creating the file. For example, a text file may be distinguished by an extension such as [file name].txt, an MS-word file by [file name].doc (docx), and a Hangul file by [file name].hwp. In addition, the extension of an image file may be classified into gif, jpg, png, tif, and the like.

In addition, an execution file, which is a computer file performing a task directed according to a coded command, may be classified into [filename].com, [filename].exe, [filename].bat, [filename].dll, [filename].sys, [filename].scr, and the like.

The hash information of the attached file may guarantee integrity of information by inspecting forgery and alteration of the information. The hash information or hash value may be mapped to a bit string of a predetermined length for arbitrary data having a predetermined length through a hash function.

Through this, hash information output through the hash function for the initially created attached file has a unique value. The output hash information or hash value has a unidirectionality that does not allow extraction of data inversely input into the function. In addition, the hash function may guarantee avoidance of collision that cannot be accomplished by calculation of another input data that provides an output the same as the hash information or hash value output for one given input data. Accordingly, when data of the attached file is changed or added, the hash function returns a different output value.

As the unique hash information of the attached file allows comparison of hash information or hash value for a file exchanged through a mail in this way, modification, forgery, alteration of the file can be confirmed. In addition, since the hash information is fixed as a unique value, preventive measures can be taken in advance by utilizing reputation information, which is a database of history for the files created with a malicious intent. In addition, the hash function may be used in a technique and version that can guarantee unidirectionality and collision avoidance.

For example, the hash information may be used as information for searching for existence of malware in a file through a Virus Total website or a Malwares website. Information such as a file provider, a hash value of a file, and the like may be provided through a website that provides analysis of hash information of the file. In addition, as a result of searching for the hash information of a file may be used to cross-check the reputation information determined by global companies that provide a number of IT information security solutions, it is possible to determine with more reliable information.

According to a preset security threat architecture, the security threat inspection unit 130 may process step-by-step matching of a mail security process corresponding to the mail information, inspect the mail information by the matching-processed mail security process, and store and manage mail security inspection information according to a result of the inspection.

The security threat architecture may be classified into a spam mail security threat, a malware security threat, a social engineering security threat, and an internal information leakage security threat. The type, level, process, priority, and processing order of the security threats may be set by the security threat architecture

The mail security process corresponding to the security threat architecture may include a spam email security process, a malware security process, a phishing mail security process, a mail export security process, and the like.

The mail security process may be determined as a different mail security process corresponding to whether the mail is an inbound mail or an outbound mail according to the security threat architecture. In addition, the inspection order or the inspection level of the mail security process may be determined by a preset security stage and architecture.

As for the mail security process, an independently separated process is allocated as a resource when mail information for reception or transmission is transmitted from the user terminal 200, and the flexible resource allocation method that can be immediately executed in an inspection area allocated from the mail information may be explained as the concept of virtual space. In the method of allocating resources to the virtual space, the mail security process may immediately process a task in the inspection area allocated from sequentially inbound mail information upon completion of processing.

In contrast, an environment in which a predetermined process that is limited to be performed with one resource like a virtual environment or a virtual machine is allocated may have an idle time, during which other processes should wait for a specific process to be completed, to process a requested task. In the analysis method performed through a process, flexible resources may be advantageous in terms of processing speed and performance compared to fixed resources.

The security threat inspection unit 130 may classify mails for reception or transmission purposes according to the mail information collected by the collection unit 120. Thereafter, the security threat inspection unit 130 may acquire mail security inspection information for each mail by matching and analyzing the mail security processes sequentially or on the basis of a set priority.

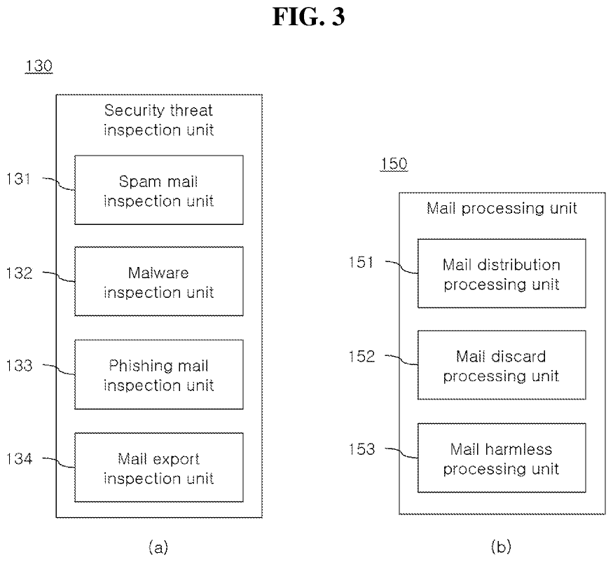

As shown in FIG. 3(a), the security threat inspection unit 130 includes a spam mail inspection unit 131, a malware inspection unit 132, a phishing mail inspection unit 133, and a mail export inspection unit 134.

First, the spam mail security threat may include mail types unilaterally and indiscriminately distributed to unspecified many people in large quantities for the purpose of advertisement, public relations, and the like between unrelated senders and receivers. In addition, a large quantity of spam mails may impose load on the data processing power of the mail system and lower the processing capability of the system. In addition, the spam mail has a risk in that users may be unintentionally linked to indiscriminate information included in the message body or the like, and it may be disguised as information for potential phishing scam.

To detect and filter the spam mails, the security threat inspection unit 130 may include a spam mail inspection unit 131. When the mail security process is a spam mail security process, the spam mail inspection unit 131 may match the mail information including mail header information, mail subject, mail message body, the number of times of receiving mail during a predetermined period, and the like to preset spam indexes step by step.

The spam mail inspection unit 131 may use mail information including mail header information, mail subject, mail message body, and the like as inspection items in the spam indexes through a predetermined pattern inspection or the like that may classify a mail as a spam mail. Through this, the spam mail inspection unit 131 may acquire, store, and manage spam mail inspection information by matching the spam indexes step by step.

Inspection items based on the items included in the mail information and level values obtained through the inspection may be set as the spam indexes in steps. According to an embodiment of the present invention, the spam indexes may be subdivided and configured in steps of Level 1, Level 2, Level 3, . . . , Level [n].

Spam index level 1 may match the mail subject data included in the mail information on the basis of big data and reputation information. Through this, spam index level 1 may acquire an evaluated level value as inspection information of spam index level 1. The level value may be set to information that can be measured quantitatively. For example, when the mail subject, which is an inspection item, includes a phrase such as ‘advertisement’, ‘public relations’, or the like, and matches the information defined as a spam mail in the big data and reputation information, the inspection information of spam index Level 1 may be evaluated as ‘1’ among the level values classified into 0 and 1. Through this, inspection information of spam index level 1 may be acquired as ‘1’.

In addition, spam index level 2 may match the data included in the mail information based on user specified keywords. Through this, spam index level 2 may acquire an evaluated level value as inspection information of spam index level 2. For example, when the mail message body, which is an inspection item, includes keywords including ‘special price’, ‘super special price’, ‘on sale’, ‘sale’, ‘sold out’, or the like, and matches the information defined as a spam mail in the user specified keywords, the inspection information of spam index level 2 may be evaluated as ‘1’ among the level values classified into 0 and 1. Through this, inspection information of spam index level 2 may be acquired as ‘1’.

As the next step, spam index level 3 may match the data included in the mail information based on image analysis. Through this, spam index level 3 may acquire an evaluated level value as inspection information of spam index level 3. For example, when the data extracted by analyzing an image included in the email message body, which is an inspection item, includes a phone number starting with ‘080’, or the like, and matches the information defined as a spam mail in the image analysis, the inspection information of spam index level 3 may be evaluated as ‘1’ among the level values classified into 0 and 1. Through this, inspection information of spam index level 3 may be acquired as ‘1’.

In this way, the inspection information acquired in units of spam index levels through the spam mail security process may be finally summed up as ‘3’ and stored and managed as spam mail inspection information. The spam mail inspection information summed up in this way may be included and managed in the mail security inspection information and used as security threat determination information in the mail processing unit 150.

The security threat inspection unit 130 may further include a malware inspection unit 132. When the mail security process is a malware security process, the malware inspection unit 132 matches the mail information, further including the extension of an attached file, the hash information of the attached file, the name of the attached file, the message body of the attached file, and Uniform Resource Locator (URL) information, with preset malware indexes in steps.

The malware inspection unit 132 may use the message body of the attached file and Uniform Resource Locator (URL) information included in the message body, together with the extension of the attached file, the hash information of the attached file, the name of the attached file, and the like that can be confirmed from the attribute values of the attached file, as malware index inspection items. Through this, the malware inspection unit 132 may acquire, store, and manage malware inspection information by matching the malware indexes in steps according to each item.

Inspection items based on the items included in the mail information and level values obtained through the inspection may be set as the malware indexes in steps. According to an embodiment of the present invention, the malware indexes may be subdivided and configured in steps of Level 1, Level 2, Level 3, . . . , Level [n].

Malware index level 1 may match the name of an attached file or the extension of the attached file included in the mail information on the basis of big data and reputation information. Through this, malware index level 1 may acquire an evaluated level value as inspection information of malware index level 1. For example, when the name of an attached file or the extension of the attached file, which are inspection items, includes ‘Trojan’ or ‘exe’, and matches the information defined as malware in the big data and reputation information, the inspection information of malware index level 1 may be evaluated as ‘1’ among the level values classified into 0 and 1. Through this, inspection information of malware index level 1 may be acquired as ‘1’.

In addition, malware index level 2 may match hash information of an attached file of a mail on the basis of big data and reputation information. Through this, an evaluated level value may be acquired as inspection information of malware index level 2. For example, when the hash information of the attached file, which is an inspection item, is analyzed as ‘a1b2c3d4’, and matches the information defined as malware in the reputation information, the inspection information of malware index level 2 may be evaluated as ‘1’ among the level values classified into 0 and 1. Through this, inspection information of malware index level 2 may be acquired as ‘1’.

As the next step, malware index level 3 may match uniform resource locator (URL) information included in the attached file or the mail message body on the basis of URL reputation information. Through this, an evaluated level value may be acquired as inspection information of malware index level 3. For example, when the URL information, which is an inspection item, is confirmed as ‘www.malicious-code.com’, and matches the information defined in the URL reputation information as a harmful site including a malware file, the inspection information of malware index level 3 may be evaluated as ‘1’ among the level values classified into 0 and 1. Through this, inspection information of malware index level 3 may be acquired as ‘1’. In addition, the malware inspection unit 132 may respond to zero-day attacks that may be omitted in the URL reputation information. The malware inspection unit 132 may change a link IP address of a URL without having reputation information to the IP address of a specific system and provide the changed IP address to the user terminal 200. When the user terminal 200 desires to access the URL, it may access the IP address of the specific system changed by the malware inspection unit 132. The specific system that has been previously changed to the link IP address of the URL may continuously inspect whether or not malware is included up to the endpoint of the URL.

In this way, the inspection information acquired in units of malware index levels through the malware security process may be finally summed up as ‘3’ and stored and managed as malware inspection information. The malware inspection information summed up in this way may be included and managed in the mail security inspection information and used as security threat determination information in the mail processing unit 150.

The security threat inspection unit 130 may further include a phishing mail inspection unit 133. The phishing mail inspection unit 133 may match, when the mail security process is a phishing mail security process, relationship analysis information acquired through the relationship analysis unit 140 to a preset relationship analysis index step by step. The relationship analysis information may be acquired through analysis of the mail information including mail information and attribute information of a mail confirmed as normal.

The phishing mail inspection unit 133 may use the inbound mail domain, outbound mail domain, inbound mail address, outbound mail address, mail routing information, mail message body information, and the like, which can be extracted from a mail determined as normal, as relationship analysis index inspection items. Through this, the phishing mail inspection unit 133 may acquire, store, and manage phishing mail inspection information by matching the relationship analysis indexes step by step according to the items. Through this, the phishing mail inspection unit 133 may detect look-alike domains and filter mails that may pose a security threat by tracing or verifying mail delivery routes.

Inspection items based on the relationship analysis information and level values obtained through inspection may be set as the relationship analysis indexes step by step.

According to an embodiment of the present invention, the relationship analysis indexes may be subdivided and configured in steps of Level 1, Level 2, Level 3, . . . , Level [n].

Relationship analysis index level 1 may match the domain of the sender's mail, the address of the sender's mail, and the like on the basis of reputation information. Through this, an evaluated level value may be acquired as inspection information of relationship analysis index level 1. For example, when the domain of an outbound mail is ‘@phishing.com’ and the sender's mail address includes ‘phishing@’, which are inspection items, and matches the information defined as malware in the reputation information, the inspection information of relationship analysis index level 1 may be evaluated as ‘1’ among the level values classified into 0 and 1.

Additionally, relationship analysis index level 2 may match the domain of the sender's mail, the address of the sender's mail, and the like on the basis of the relationship analysis information. Through this, an evaluated level value may be acquired as inspection information of relationship analysis index level 2. For example, when the domain of an outbound mail is ‘@phishing.com’ and the sender's mail address includes ‘phishing@’, which are inspection items, and does not match the information defined as attribute information of a normal mail in the relationship analysis information, the inspection information of relationship analysis index level 2 may be evaluated as ‘1’ among the level values classified into 0 and 1. Through this, inspection information of relationship analysis index level 3 may be acquired as ‘1’.

As the next step, relationship analysis index level 3 may match mail routing information or the like on the basis of the relationship analysis information. Through this, an evaluated level value may be acquired as inspection information of relationship analysis index level 3. For example, when the mail routing information, which is an inspection item, is confirmed as ‘1.1.1.1’, ‘2.2.2.2’, and ‘3.3.3.3’, and the routing information, which is the mail transmission path, does not match the information defined as attribute information of a normal mail in the relationship analysis information, the inspection information of relationship analysis index level 3 may be evaluated as ‘1’ among the level values classified into 0 and 1. Through this, inspection information of relationship analysis index level 3 may be acquired as ‘1’.

In this way, the inspection information acquired in units of relationship analysis index levels through the phishing mail security process may be finally summed up as ‘3’ and stored and managed as phishing mail inspection information. The phishing mail inspection information summed up in this way may be included and managed in the mail security inspection information, and may be used as security threat determination information in the mail processing unit 150.

The security threat inspection unit 130 may include a mail export inspection unit 134 to respond to internal information leakage security threats. The mail export inspection unit 134 may match, when the mail security process is a mail export security process, mail information to a preset mail export management index on the basis of the mail information step by step.

The mail export inspection unit 134 may use the attribute information of the mail information as a mail export management index inspection item. In addition, the management index inspection item may use internally managed information on the IP address assigned to the user terminal 200.

Inspection items set in advance and level values obtained through inspection may be set in steps as the mail export management indexes. According to an embodiment of the present invention, the mail export management indexes may be subdivided and configured in steps of Level 1, Level 2, Level 3, . . . , Level [n].

The mail export management index may include an item for controlling to register only allowed IP addresses among the IP addresses assigned to the user terminal 200 as mail information for the inspecting the outbound environment. Since an unauthenticated user terminal is likely to leak internal information and likely to pose a security threat through a mail, management indexes for preventing the leakage and threat may be managed.

In addition, the mail export inspection unit 134 may classify the mail export management indexes into inspection items such as information on the IP address, information on the number of times of transmission, and the like. In addition, the mail export inspection unit 134 may reduce the threat of internal information leakage by additionally including a control unit, such as an approval process or the like, as an item for inspecting the outbound environment of mail. Through this, the mail export inspection unit 134 may store and manage level values, calculated by matching the inspection item through the mail export process, as mail export inspection information.

The relationship analysis unit 140 may store and manage relationship analysis information acquired through analysis of the mail information and the trust authentication log. When the record management unit 170 processes mail information as a normal mail according to the security threat determination information, the trust authentication log may include record information including the inbound mail domain, outbound mail domain, inbound mail address, outbound mail address, mail routing information, mail message body information, and the like.

The mail processing unit 150 may process a mail state according to security threat determination information acquired through analysis of the mail security inspection information and the mail information.

The mail processing unit 150 may perform the mail security process according to a preset priority. When the security threat determination information acquired through the mail security process is determined as an abnormal mail, the mail processing unit 150 may process the mail state by determining whether or not to stop subsequent mail security processes. Through this, when a problem is found first at the inspection step, the mail processing unit 150 may perform only the processes needed at the inspection step according to the priority, determine whether or not to stop the inspection, and terminate the process without performing subsequent inspection steps. Through this, complexity of the system can be reduced and processing efficiency can be improved by securing efficiency of the mail security service.

Information acquired by combining spam mail inspection information, malware inspection information, phishing mail inspection information, and mail export inspection information calculated by the security threat inspection unit 130 may be used as the mail security inspection information. For example, when the score calculated from the spam mail inspection information is ‘3’, the score calculated from the malware inspection information is ‘2’, the score calculated from the phishing mail inspection information ‘1’, and the score calculated from the mail export inspection information is ‘0’, the score summed up as the mail security inspection information through the process performed on the mail information by the security threat inspection unit 130 may be acquired as ‘7’. At this point, the mail may be classified as a normal mail when the overall score is in a range of 0 to 3 on the basis of the preset security threat determination information, as a gray mail when the overall score is in a range of 4 to 6, and as an abnormal mail when the overall score is in a range of 7 to 12. Accordingly, a mail of which the mail security inspection information is ‘7’ may be determined as an abnormal mail. In addition, a result value of each inspection information item included in the information on mail information inspection may be assigned with an absolute priority according to the item, or the priority may be determined by the information according to a weight.

Accordingly, as shown in FIG. 3(b), the mail processing unit 150 includes a mail distribution processing unit 151, a mail discard processing unit 152, and a mail harmless processing unit 153.

The mail processing unit 150 may include a mail distribution processing unit 151 for processing a mail determined as a normal mail according to the security threat determination information to put the mail into a receiving or sending state that can be processed by the user terminal.

In addition, the mail processing unit 150 may further include a mail discard processing unit 152 for processing a mail determined as an abnormal mail according to the security threat determination information to put the mail into a state that does not allow access of the user terminal.

In addition, the mail processing unit 150 may further include a mail harmless processing unit 153 for converting a mail determined as a gray mail according to the security threat determination information into non-execution file contents, and providing the non-execution file contents so that the user terminal may selectively process the mail state.

Generally, a gray mail may be classified into a spam mail or a junk mail, or may be classified as a normal mail on the contrary. In the present invention, the gray mail may be defined as a mail type that is classified when the security threat determination information is calculated as a medium value in a predetermined range, which cannot be determined as normal or abnormal. The mail harmless processing unit 153 may convert the gray mail including the message body of suspicious contents into an image file and provides the mail in a state that the user terminal 200 may confirm. In addition, the mail harmless processing unit 153 may remove or modify a part in an attached file being suspicious of malware and provide the mail to the user terminal 200.

Meanwhile, the user information management unit 160 may store and manage user information of the user terminal 10, and the user information may include, for example, at least one among user name information, email account information, access IP information, phone number information, access device information, MAC information, and the like.

In addition, the record management unit 170 may store and manage the mail information processed according to the security threat determination information as record information. The record management unit 170 may further include a relationship information management unit 171 for storing and managing, when a mail is processed as a normal mail according to the security threat determination information, the record information including the inbound mail domain, outbound mail domain, inbound mail address, outbound mail address, mail routing information, mail message body information, and the like as a trust authentication log. Through this, the trust authentication log may be used for reliable relationship information analysis on the recipient's and sender's mail information. In addition, reliability of the information included in the trust authentication log can be guaranteed as data are continuously accumulated through exchange of information therebetween.

In addition, when a mail is processed as an abnormal mail according to the security threat determination information, the record management unit 170 may use the record information including the inbound mail domain, outbound mail domain, inbound mail address, outbound mail address, mail routing information, mail message body information, and the like as an index for determining an abnormal mail when the mail security process is performed.

The vulnerability test unit 180 may convert a mail determined as an abnormal mail according to the security threat determination information into non-execution file contents, and provide the non-execution file contents so that the user terminal may receive or transmit. The vulnerability test unit 180 may include a vulnerability information management unit 181 for acquiring identification information of the user terminal receiving or transmitting the abnormal mail, and storing and managing the identification information as vulnerability information of each type.

Meanwhile, when mail server access request information is received from the external mail access device 400 through the communication unit 125 on the basis of access path information based on the mail communication protocol previously distributed to the outside of the security network of the mail access security system, the mail r access security authentication processing unit 190 performs an authentication process of acquiring one or more pieces of detailed access information included in the mail server access request information by inputting the mail server access request information into a communication protocol processing module for mail engine used by the security threat inspection unit 130 and the mail processing unit 150, and determining whether or not to block the access using the one or more pieces of detailed access information.

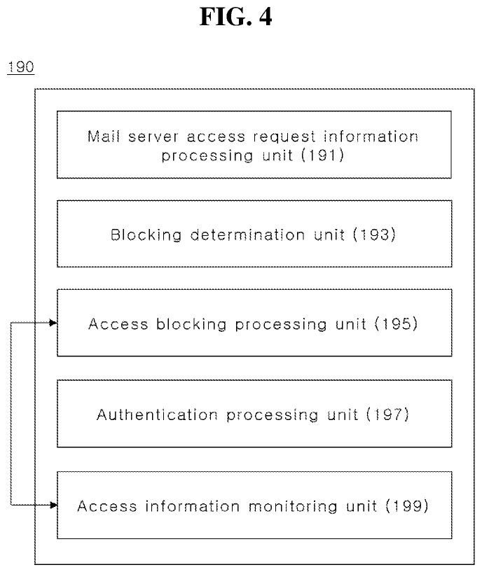

To this end, referring to FIG. 4, the mail server access security authentication processing unit 190 includes a mail server access request information processing unit 191, a blocking determination unit 193, an access blocking processing unit 195, and an authentication processing unit 197, and an access information monitoring unit 199.

More specifically, first, the mail server access request information processing unit 191 may process mail server access request information received from an external mail access device on the basis of access path information based on the mail communication protocol previously distributed to the outside of the security network of the mail access security system through the communication unit 125.

To this end, the mail server access request information processing unit 191 may configure access path information based on a preset mail communication protocol in correspondence to the inbound mail security device 100, and distribute the access path information based on a preset mail communication protocol to the external mail access device 400. Here, various methods such as broadcasting through a public network or other private servers, uploading to a webpage provided by a separate accessible information server, or delivering by an email or other electronic messages of various formats may be exemplified as the distribution method.

Accordingly, the mail server access request information processing unit 191 may receive the mail server access request information of the external mail access device 400, which is configured using a communication protocol for mail engine encrypted based on the Transport Layer Security Protocol (TLS), through the communication unit 125. As described above, at least one among the Simple Mail Transfer Protocol (SMTP) standard protocol, Post Office Protocol 3 (POP3) standard protocol, Internet Message Access Protocol (IMAP) standard protocol, and Messaging Application Programming Interface (MAPI) may be used as the communication protocol for mail engine encrypted using the TLS method.

In addition, the mail server access request information processing unit 191 may acquire one or more pieces of detailed access information included in the mail server access request information by inputting the mail server access request information into a communication protocol processing module for mail engine of the control unit 110 used by the security threat inspection unit 130 and the mail processing unit 150, and detailed access information may be transferred to the blocking determination unit 193.

Here, the detailed access information is acquired by decoding at least a part of an email server access request packet according to a communication protocol for mail engine, and may include at least one among mail user identification information, encrypted mail user password information, device identification information, access IP information, access location information, access time information, and identification information of communication protocol for mail engine.

That is, the mail server access request information is information obtained by encrypting information on the request of the external mail access device 400 for accessing the conventional mail server 300 according to a communication protocol for mail engine, and the mail server access request information processing unit 191 may decrypt at least a part of the mail server access request information using the communication protocol processing module for mail engine, and extract and transmit detailed access information to the blocking determination unit 193.

In addition, the blocking determination unit 193 may use the detailed access information to calculate in advance the possibility of the mail server access request information to respond to an access attack based on a communication protocol for mail engine, and process blocking of the mail server access request information when the possibility of responding to an access attack based on a communication protocol for mail engine is greater than a threshold.

To this end, the blocking determination unit 193 may determine whether there is an access attack based on a communication protocol for mail engine and whether or not to block the access attack using the detailed access information according to a preset access blocking algorithm.

For example, when the blocking policy information previously configured in correspondence to the mail user identification information matches at least one among the device identification information, the access IP information, the access location information, the access time information, and the identification information of communication protocol for mail engine, the blocking determination unit 193 may determine to block the access.

The blocking policy information may include learning-based blocking policy information variably configured according to learning data of activity information previously collected in correspondence to the mail user identification information, and the activity information may include at least one among device identification information, access IP information, access location information, access time information, and identification information of communication protocol for mail engine corresponding to the mail user identification information.

Here, the learning-based blocking policy information variably configured according to the learning data may be configured by a machine learning model that has learned by associating, on the basis of deep learning, device identification information, access IP information, access location information, access time information, and identification information of communication protocol for mail engine corresponding to the mail user identification information with learning data of a preset attack case. Here, various machine learning techniques such as well-known CNN, RNN, DNN, LSTM, regression analysis, and the like may be used as the deep learning-based associative learning technique.

For example, when the IP information of the detailed access information acquired from the access request information based on the communication protocol for mail engine of the external mail access device 400 is different from the IP address learned in advance or specified in the blocking policy information, the blocking determination unit 193 according to an embodiment of the present invention may block access of the external mail access device 400.

In addition, for example, when the access country information of the detailed access information acquired from the access request information based on the communication protocol for mail engine of the external mail access device 400 is different from the country information learned in advance or specified in the blocking policy information, the blocking determination unit 193 according to an embodiment of the present invention may block access of the external mail access device 400.

In addition, for example, when the identification information of communication protocol for mail engine of the detailed access information acquired from the access request information based on the communication protocol for mail engine of the external mail access device 400 is different from the identification information of communication protocol for mail engine learned in advance or specified in the blocking policy information, the blocking determination unit 193 according to an embodiment of the present invention may block access of the external mail access device 400. More specifically, when an access using another protocol such as IMAP is suddenly generated from the external mail access device 400 more than a predetermined number of times within a predetermined period of time while a specific user is using an email application for more than a predetermined period of time using only the POP3 protocol, the blocking determination unit 193 may block access of the external mail access device 400.

In addition, for example, even when the device identification information of the detailed access information acquired from the access request information based on the communication protocol for mail engine of the external mail access device 400 is different from the device identification information learned in advance or specified in the blocking policy information, the blocking determination unit 193 according to an embodiment of the present invention may block access of the external mail access device 400.

The blocking determination unit 193 may set in advance the conditions on the predetermined period of time and the predetermined number of times for blocking an access. For example, when the possibility of an attack is determined to be higher than a threshold, or when access request information based on a communication protocol for mail engine having detailed access information that does not match the blocking policy is received more than a predetermined number of times within a predetermined period of time, the blocking determination unit 193 may block the access. Settings the period of time and the number of times may be processed differently for each type and case of detailed access information.

Meanwhile, the access blocking processing unit 195 may block access of the external mail access device 400, which is determined to be blocked by the blocking determination unit 193, to the mail server 300. However, the access blocking processing unit 195 may confirm response information according to the inquiry of the user terminal 10 prior to the blocking process, and determine whether or not to block the access according to the response information.

For example, the access blocking processing unit 195 may inquire the user terminal 10, which is set in advance in correspondence to the mail user identification information, whether or not to block the mail server access request information in response to the access request information based on the communication protocol for mail engine that is determined to be blocked as the identification information of communication protocol for mail engine set in advance by the blocking determination unit 193 in correspondence to the mail user identification information is different from the identification information of communication protocol for mail engine, determine to block the access according to the response data received from the user terminal 10 in response to the inquiry, and block access of the external mail access device 400. The access blocking processing unit 195 may configure blocking response information according to blocking the access and transmit the blocking response information to the external mail access device 400.

Accordingly, communication with the mail server 300 based on a communication protocol for mail engine is blocked in the external mail access device 400 determined to be an attacker, and normal data transmission and reception with the mail server 300 based on a communication protocol for mail engine can be performed only when unblocking such as identity authentication or the like is performed through a separate path.

Furthermore, the access blocking processing unit 195 may transmit detailed access information of access request information based on a communication protocol for mail engine, of which the access has been blocked, to the access information monitoring unit 199.

In addition, the access information monitoring unit 199 may classify and determine an attack type by analyzing the detailed access information of the access request information based on a communication protocol for mail engine, of which the access has been blocked. For example, when repeated email account login attempts corresponding to the same account are confirmed, the access information monitoring unit 199 may determine the attempt as a password theft attack, and when multiple accounts are accessed in large numbers from completely different countries, it may also be determined as a spam or malware attack.

In addition, the access information monitoring unit 199 may configure the classified attack type information as a report interface and provide it to the user terminal 10.

Meanwhile, the authentication processing unit 197 may transfer authentication inquiry information including the mail user identification information and the encrypted mail user password information to the mail server 300 on the basis of the mail server access request information that is not blocked according to the determination of whether or not to block the access, and transfer the mail server access request information to the mail server 300 according to the authentication response of the mail server 300 corresponding to the authentication inquiry information.

Then, the authentication processing unit 197 may acquire mail server access response information corresponding to the mail server access request information from the mail server 300, and transmit the mail server access response information to the external mail access device 400.

Accordingly, the authentication processing unit 197 may allow a normal access based on a communication protocol for mail engine, of which the access is not blocked, and as the inbound and outbound mail data after the access authentication is protected by the security threat inspection unit 130 and the mail processing unit 150, vulnerability of the system is resolved, and a safe mail security system can be provided.

Although the operation of the inbound mail security device 100 has been mainly described in an embodiment of the present invention, the function and operation of blocking the mail server access request information based on a protocol for mail engine may also be configured in the outbound mail security device 200 in the same way. Accordingly, the mail server access security authentication processing unit 190 according to an embodiment of the present invention may operate in the same manner although it is connected to the outbound mail security device 200. That is, as described above, the inbound mail security device 100 and the outbound mail security device 200 according to an embodiment of the present invention may configure a single mail security device that commonly includes the mail server access security authentication processing unit 190, and it is not limited by the name.

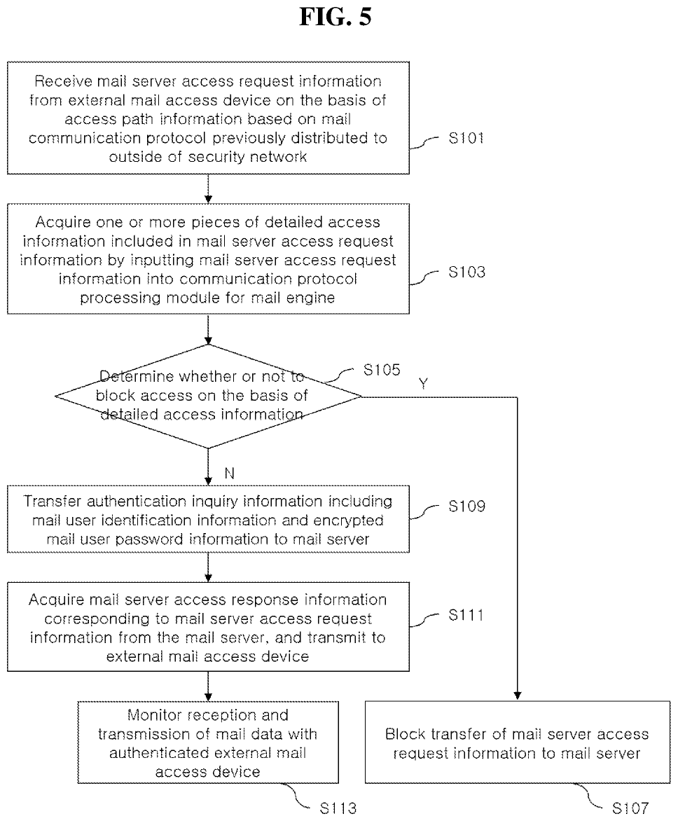

FIG. 5 is a flowchart for explaining the operation of a mail security device according to an embodiment of the present invention.

Referring to FIG. 5, the mail security device 100 according to an embodiment of the present invention first receives mail server access request information from the external mail access device 400 on the basis of access path information based on a mail communication protocol previously distributed to the outside of the security network (S101).

Then, the mail security device 100 acquires one or more pieces of detailed access information included in the mail server access request information by inputting the mail server access request information into a communication protocol processing module for mail engine (S103).

Thereafter, the mail security device 100 determines whether or not to block the access on the basis of the detailed access information (S105).

When it is determined to block the access, the mail security device 100 transfers authentication inquiry information including mail user identification information and encrypted mail user password information to the mail server 300 (S109).

Then, the mail security device 100 acquires mail server access response information corresponding to the mail server access request information from the mail server 300 and transmits the mail server access response information to the external mail access device (S111).

Thereafter, the mail security device 100 may monitor reception and transmission of mail data with an authenticated external mail access device (S113) to perform a security threat inspection and further block spam mail, malicious mail, social engineering attacks, and the like according to the mail contents.

Meanwhile, when it is determined to block the access at step S105, the mail security device 100 blocks transfer of the mail server access request information of the external mail access device 400 to the mail server 300 (S107).

Here, blocking response information by the blocking may be configured and transferred to the external mail access device 400. The blocking response information may include, for example, additional external user authentication request information. In this case, the external mail access device 400 may perform external user authentication separately, configure mail server access request information including an authentication value, and request access again from the mail security device 100, and when mail server access request information including the authentication value is received, the mail security device 100 may release the access blocking and perform steps S109 to S113 again.

The methods according to the present invention described above may be manufactured as a program to be executed on a computer and stored in a computer-readable recording medium, and examples of the computer-readable recording medium include ROM, RAM, CD-ROM, magnetic tapes, floppy disks, optical data storage devices and the like.

The computer-readable recording medium may be distributed in computer systems connected through a network, so that computer-readable codes may be stored and executed in a distributed manner. In addition, functional programs, codes, and code segments for implementing the method may be easily inferred by the programmers in the art to which the present invention belongs.

In addition, although preferred embodiments of the present invention have been illustrated and described above, the present invention is not limited to the specific embodiments described above, and various modified embodiments can be made by those skilled in the art without departing from the gist of the invention claimed in the claims, and in addition, these modified embodiments should not be individually understood from the spirit or perspective of the present invention.

1. An operation method of a mail security device that configures a security network of a mail access security system and includes a security threat inspection unit for performing a security threat inspection corresponding to an inbound mail, and a mail processing unit for transferring the mail for which the security threat inspection has been completed to a mail server in the security network, the method comprising the steps of:
receiving mail server access request information from an external mail access device on the basis of access path information based on a mail communication protocol previously distributed to the outside of the security network of the mail access security system, by the mail security device;
acquiring one or more pieces of detailed access information included in the mail server access request information by inputting the mail server access request information into a communication protocol processing module for mail engine used by the security threat inspection unit and the mail processing unit, by the mail security device;
determining whether or not to block the access using the one or more pieces of detailed access information, by the mail security device; and
blocking transfer of the mail server access request information to the mail server according to the determination of whether or not to block the access, by the mail security device.

2. The method according to claim 1, wherein the mail server access request information is configured using a communication protocol for mail engine encrypted based on the Transport Layer Security Protocol (TLS) as the communication protocol.

3. The method according to claim 2, wherein the communication protocol for mail engine includes at least one among a Simple Mail Transfer Protocol (SMTP) standard protocol, a Post Office Protocol 3 (POP3) standard protocol, an Internet Message Access Protocol (IMAP) standard protocol, and a Message Application Programming Interface (MAPI) standard protocol.

4. The method according to claim 1, wherein the one or more pieces of detailed access information includes at least one among mail user identification information, encrypted mail user password information, device identification information, access IP information, access location information, access time information, and identification information of communication protocol for mail engine.

5. The method according to claim 4, wherein the step of determining whether or not to block the access includes the step of determining to block the access when blocking policy information previously configured in correspondence to the mail user identification information matches at least one among the device identification information, the access IP information, the access location information, the access time information, and the identification information of communication protocol for mail engine.

6. The method according to claim 5, wherein the blocking policy information includes learning-based blocking policy information variably configured according to learning data of activity information previously collected in correspondence to the mail user identification information, and the activity information includes at least one among the device identification information, the access IP information, the access location information, the access time information, and the identification information of communication protocol for mail engine corresponding to the mail user identification information.

7. The method according to claim 4, wherein the step of determining whether or not to block the access includes the steps of:
inquiring the user terminal, which is set in advance in correspondence to the mail user identification information, whether or not to block the mail server access request information, when the identification information of communication protocol for mail engine set in advance in correspondence to the mail user identification information is different from the identification information of communication protocol for mail engine; and
determining to block the access according to response data received from the user terminal in response to the inquiry.

8. The method according to claim 4, further comprising the steps of:
transferring authentication inquiry information including the mail user identification information and the encrypted mail user password information to the mail server on the basis of the mail server access request information that is not blocked according to the determination of whether or not to block the access; and
transferring the mail server access request information to the mail server according to an authentication response of the mail server corresponding to the authentication inquiry information.

9. The method according to claim 8, further comprising the steps of:
acquiring mail server access response information corresponding to the mail server access request information from the mail server; and
transmitting the mail server access response information to the external mail access device.

10. A mail security device that configures a security network of a mail access security system and includes a security threat inspection unit for performing a security threat inspection corresponding to an inbound mail, and a mail processing unit for transferring the mail for which the security threat inspection has been completed to a mail server in the security network, the device comprising:
a communication unit for receiving mail server access request information from an external mail access device on the basis of access path information based on a mail communication protocol previously distributed to the outside of the security network of the mail access security system;
a mail server access request information processing unit for acquiring one or more pieces of detailed access information included in the mail server access request information by inputting the mail server access request information into a communication protocol processing module for mail engine used by the security threat inspection unit and the mail processing unit;
a blocking determination unit for determining whether or not to block the access using the one or more pieces of detailed access information; and
an access blocking processing unit for blocking transfer of the mail server access request information to the mail server according to the determination of whether or not to block the access.

11. The device according to claim 10, wherein the mail server access request information is configured using a communication protocol for mail engine encrypted based on the Transport Layer Security Protocol (TLS) as the communication protocol.

12. The device according to claim 11, wherein the communication protocol for mail engine includes at least one among a Simple Mail Transfer Protocol (SMTP) standard protocol, a Post Office Protocol 3 (POP3) standard protocol, an Internet Message Access Protocol (IMAP) standard protocol, and a Message Application Programming Interface (MAPI) standard protocol.

13. The device according to claim 10, wherein the one or more pieces of detailed access information includes at least one among mail user identification information, encrypted mail user password information, device identification information, access IP information, access location information, access time information, and identification information of communication protocol for mail engine.

14. The device according to claim 13, wherein the access blocking processing unit determines to block the access when blocking policy information previously configured in correspondence to the mail user identification information matches at least one among the device identification information, the access IP information, the access location information, the access time information, and the identification information of communication protocol for mail engine.

15. The device according to claim 14, wherein the blocking policy information includes learning-based blocking policy information variably configured according to learning data of activity information previously collected in correspondence to the mail user identification information, and the activity information includes at least one among the device identification information, the access IP information, the access location information, the access time information, and the identification information of communication protocol for mail engine corresponding to the mail user identification information.

16. The device according to claim 13, wherein the access blocking processing unit inquires the user terminal, which is set in advance in correspondence to the mail user identification information, whether or not to block the mail server access request information through the communication unit, when the identification information of communication protocol for mail engine set in advance in correspondence to the mail user identification information is different from the identification information of communication protocol for mail engine, and determines to block the access according to response data received from the user terminal through the communication unit in response to the inquiry.

17. The device according to claim 10, further comprising an authentication processing unit for transferring authentication inquiry information including the mail user identification information and the encrypted mail user password information to the mail server on the basis of the mail server access request information that is not blocked according to the determination of whether or not to block the access, and transferring the mail server access request information to the mail server according to an authentication response of the mail server corresponding to the authentication inquiry information.

18. The device according to claim 17, wherein the authentication processing unit acquires mail server access response information corresponding to the mail server access request information from the mail server, and transmits the mail server access response information to the external mail access device.

19. (canceled)
